(19) United States
(12) Patent Application Publication
(10) Pub. No.: US 2015/0312276 A1
(43) Pub. Date: Oct. 29, 2015

(54) WHITE LISTS

(71) Applicants: Richard THRELKELD, Boca Raton, FL (US); Adrian GREENWOOD, London (GB)

(72) Inventors: Richard THRELKELD, Boca Raton, FL (US); Adrian GREENWOOD, London (GB)

(73) Assignee: 1E LIMITED, London (GB)

(21) Appl. No.: 14/265,297

(22) Filed: Apr. 29, 2014

(51) Int. Cl. H04L 29/06; G06F 21/57

(52) U.S. Cl. CPC H04L 63/20; G06F 21/577; G06F 2221/033

(57) ABSTRACT

A computer has an operating system having a kernel. The operating system is configured to prevent running of software not identified in a list of approved software referred to as a white list. The computer is linked by a communications link to a server which has a comparison program which compares the identities of software present on the computer with software identified in the list to determine what software installed on the computer is not on the white list. A risk determination program determines for each software not on the list whether the software complies with a plurality of risk criteria, and automatically adds to the list the identity of any software determined to be of low risk according to a risk calculation. The list is supplied to the computer. Software absent from the list is prevented from running by the kernel of the operating system.

### BACKGROUND OF THE INVENTION

1. Field of the Invention

The present application relates to controlling a computer.

2. Description of the Related Technology

It is known to perform bench marking to ensure computer systems are secure. The US government, the Australian Government and Microsoft consider that four security controls mitigate against a large proportion of software intrusions. The four controls are

1) apply Operating System patches;

2) apply third party software patches;

3) allow only applications on a “white list” (i.e. a list of allowed software), to run; and

4) limit administrator privileges.

A network of computers may have tens, or even hundreds or more, of computers and each computer may have a large number of programs installed on it. Also many users may have administrator rights granted for their computer. Some users may install software on their computers independently of the network management system. Also computers, for example laptop computers join and leave the network at random. To manually apply the controls to an existing network is a very difficult if not impossible task. The number of different application programs and different versions of the same program installed on a network is often very large. There is a need to provide software tools for facilitating the production of a list of allowed software and of controlling what software is allowed to run.

### SUMMARY

In accordance with a first embodiment of the present invention, there is provided a method of controlling a first computer, the first computer having an operating system having a kernel, the operating system being configured to prevent running of software not identified in a list of approved software, the first computer being connected to a second computer via a communications network, the method comprising running on the first computer a monitoring program which provides to the second computer data relating to the software installed on the first computer, running on the second computer a comparison program which compares the identities of software present on the computer with software identified in the list, and a risk determination program which determines for each software not on the list whether the software complies with a plurality of risk criteria, and automatically adds to the list the identity of any software determined to be of low risk; and supplying the list of the first computer whereby the operating system of the first computer prevents the running of software absent from the list.

According to a second embodiment of the invention, there is provided a computer program having instructions for controlling a first computer having an operating system having a kernel, the operating system being configured to prevent running of software not identified in a list of approved software, the program having a module for receiving from the first computer data relating to software installed on the first computer, a comparison module configured to compare the identities of software present on the computer with software identified in the list, a risk determination module configured to determine for each software not on the list whether the software complies with a plurality of risk criteria, and automatically add to the list the identity of any software determined to be of low risk; and a module for sending the list to the first computer.

Further features and advantages of the invention will become apparent from the following description of illustrative examples of the invention, given by way of example only, which is made with reference to the accompanying drawings.

### BRIEF DESCRIPTION OF THE DRAWINGS

FIG. 1 is a schematic diagram of a computer network;

FIG. 2 is a schematic diagram of an illustrative computer of the network of FIG. 1;

FIG. 3 is a flow chart of an illustrative method of creating and/or amending a list of allowed software and controlling the running of software in accordance with the list according to one or more embodiments of the present invention;

FIG. 4 is a flow chart of an illustrative method, used in combination with the method of FIG. 3, of globally monitoring and updating lists of allowed software according to one or more embodiments of the present invention; and

FIG. 5 illustrates part of a Configuration Manager according to one or more embodiments of the present invention.

### DETAILED DESCRIPTION OF CERTAIN INVENTIVE EMBODIMENTS

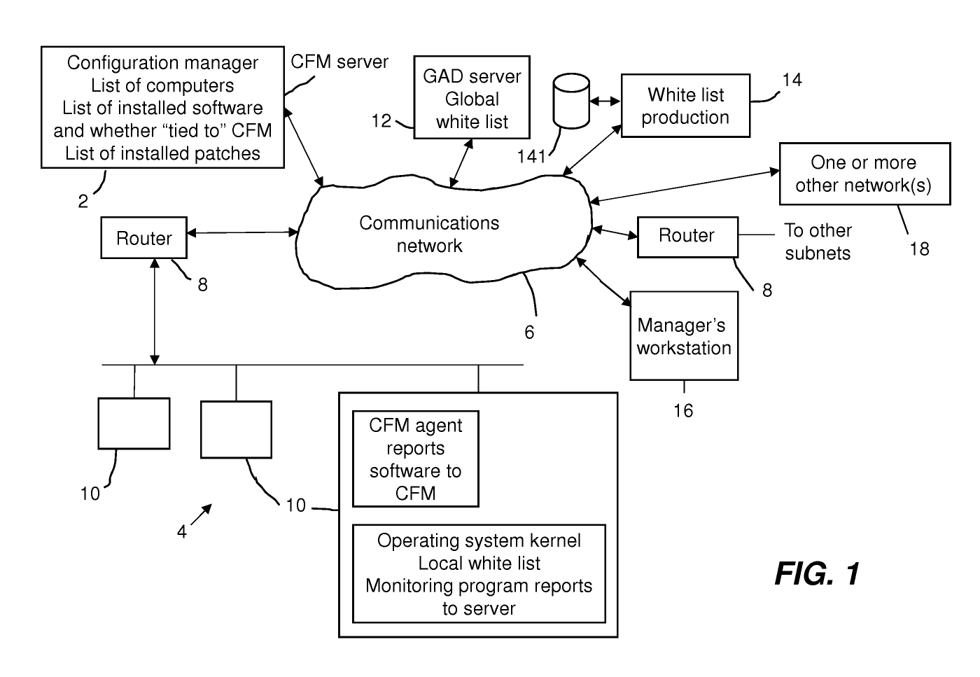

FIG. 1 illustrates an example of a network in which the present invention may be used, but those skilled in the art will appreciate the invention may be used in other networks.

The network of FIG. 1 comprises a network management system, in this example a Microsoft Configuration Manager (CFM), 2 coupled to one or more sub-networks or network branches 4 by a communications network 6 via one or more routers 8. Each sub-network 4 comprises one or more computers 10 referred to herein as local computers. Other examples of network management systems are available from other companies. The computers 10 may be of different types for example desk top computers and laptops amongst others. Portable computers such as laptops may be connected to the network only temporarily.

Each computer 10 has at least an operating system, applications software and a CFM agent. The CFM agent communicates with the CFM 2 informing the CFM 2 in known manner of software installed on the computer. Software may be installed on a computer 10 using the network management system, for example using Microsoft Installer. Software may also be installed on a computer 10 by the user if the user has administrator rights which allow that. The Configuration Manager CFM 2 stores data relating to the computers 10 and the software installed on them including data identifying the computers, data identifying the software, including patches, installed on them, and other data as will be described in more detail below. Each computer 10 stores a local list of allowed software hereinafter referred to as a “white list”.

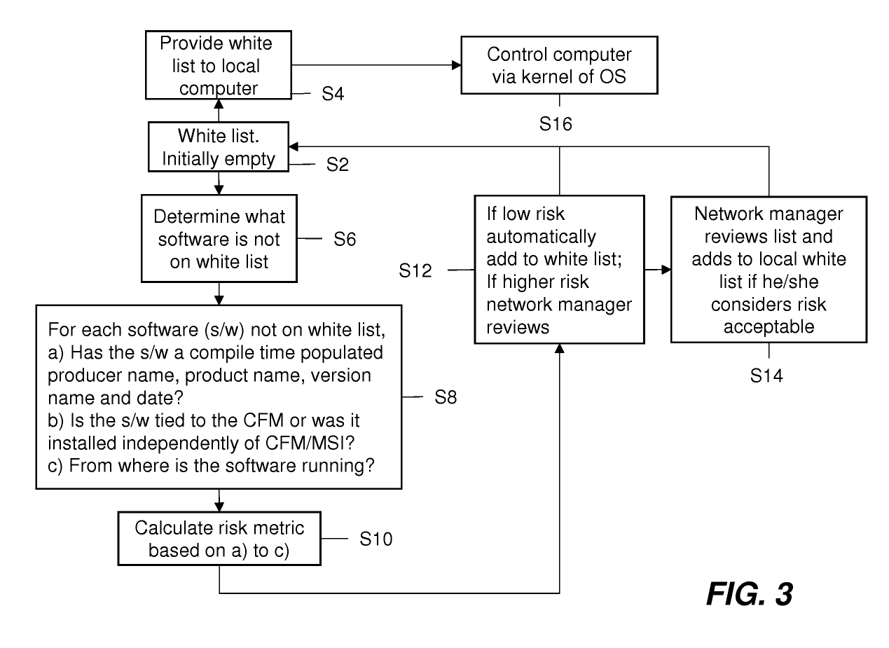

A computer 14, which may be a server, is connected to the network. The server 14 produces the local white lists for storage in the local computers 10. The server 14 automatically creates and updates each white list based on a metric calculation as will be described with reference to FIG. 3. The local computers 10 each have a monitoring program which sends data to the server to enable it to produce the local white lists.

The network of FIG. 1 also includes a computer, e.g. a server, 12 on which is a Global Active Directory (GAD). That computer 12 stores a global white list which is enforced on the local computers 10 as a policy.

The kernel of the operating system of each local computer 10 interacts with the local white list and with the GAD server in known manner to prevent running of software absent from the combination of the local and global white lists.

The network of FIG. 1 is in a domain. The server 14 maybe outside the network of FIG. 1 but connected to the network of FIG. 1. It may be connected to one or more other networks by the communications network 6 but outside their domains to provide the same monitoring service to all the networks.

The network may also have one or more workstations 16 used by one or more network managers.

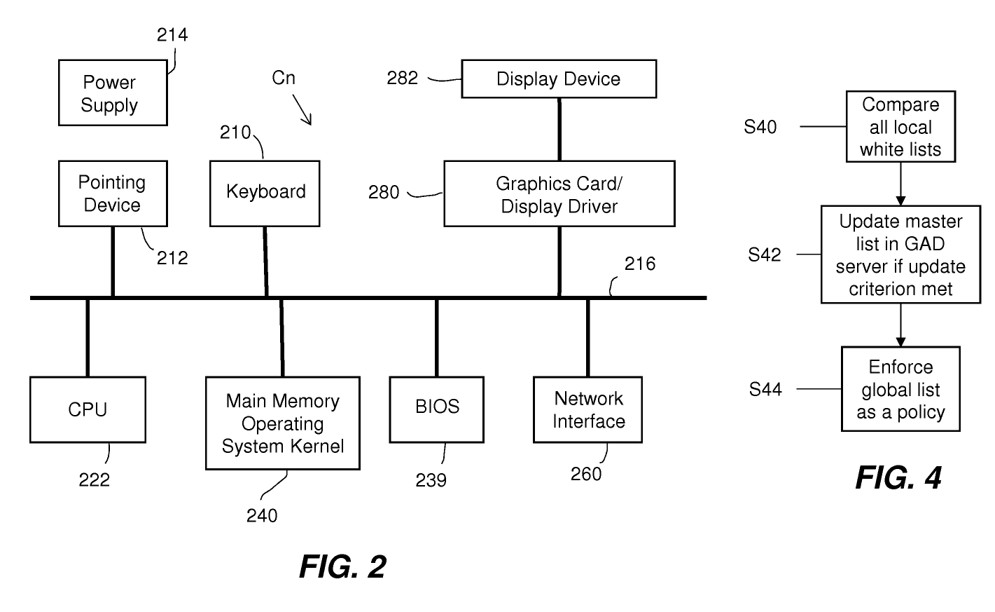

Referring to FIG. 2, an illustrative one of the computers 2, 10, 12, 14 and 16 comprises, amongst other items: a CPU 222; a main memory 240 for example a hard disk drive or other storage device, for example electronic memory; a network interface 260, a BIOS 239 and one or more busses 216. The BIOS 239 is typically a Read Only Memory (ROM). The computers may also have other items for example a display driver 280 coupled to a display device 282; human interface devices or input devices for example a keyboard 210 and a pointing device 212. The items are conventional and interact via the bus(es) 216 in a conventional way. The network interface couples the computer to the communications network 6 via the routers 10 and to other computers in the sub-network 4 having respective IP (Internet Protocol) addresses. The computer also comprises a power supply 214. Programs are stored in the main memory 240 and executed by the CPU 222. The computer has an operating system the lowest (and most important) level of which is the kernel of the operating system. In this example the operating system is stored in the main memory.

### Production and Use of White Lists

FIG. 3 is a flow chart of an illustrative method of creating and/or amending a white list and controlling a computer 10. The method of FIG. 3 is implemented by a program installed in the server 14 which receives data sent to it by the monitoring program of the computer 10. The operating system in each local computer 10 allows only software listed in the combination of the local white list and the global white list to run on the local computer. The program may be run continuously or at intervals to maintain the white list in case software installed on the computer changes. The server 14 runs the program for each of the local computers 10.

Assume as shown at S2 in FIG. 3 that the local white list for a particular local computer 10 is initially empty. In the following description, “software” means any software which is not core operating system software. The white list program at step S6 compares the (initially empty) white list with the identities of software installed in the computer 10. Initially this will be all software stored on the computer. At step S8, in this example, for each software not on the white list the white list program determines

Has the software i) a producer name, ii) a product name, iii) a version name and iv) a date, (in all four cases i) to iv) established at compile time);

Is the software i) tied to the CFM or ii) was it installed independently of the CFM and/or the installer;

Where is the software running from? For example it may run from i) the program files memory (main memory) of a computer 10 or ii) from a user temp directory or iii) from the network.

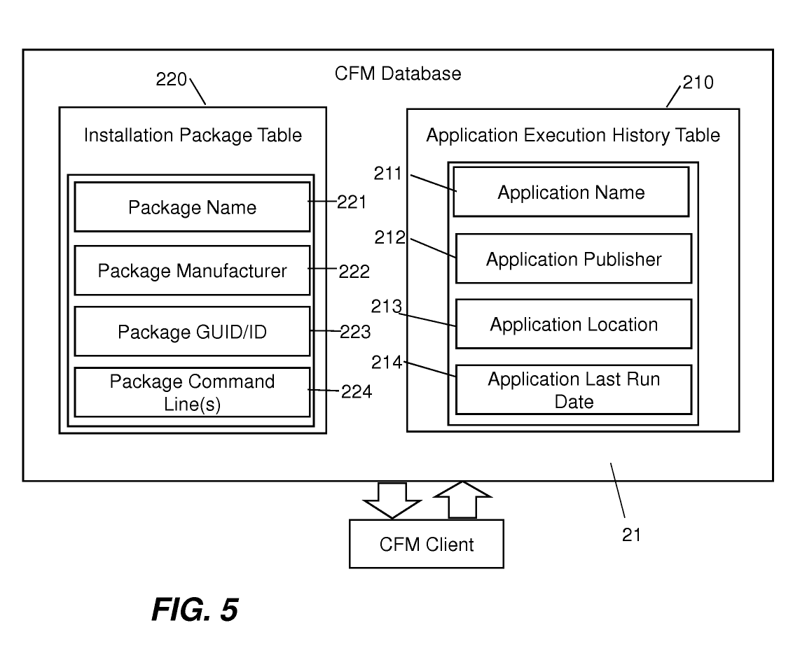

Item b) may be omitted from some implementations. It is described in more detail with respect to FIG. 5.

A risk metric is calculated in step S10. The metric applies to each of the criteria of a)i) to c)iii) a confidence factor which may be weighted. For example the metric M may be

M=w1a)i)+w2a)ii)+w3a)iii)+w4a)iv)+w5b)i)−w6b)ii+w7c)i)−w8c)ii−w8c)iii)

Where w1 to w8 are weighting factors, which could be one, and a)i) to c)iii) are confidence values relating to the like numbered criteria set out above. In this example, the greater the metric, the lower the risk of running the software.

As indicated at S12 software which has a metric greater than a predetermined value is automatically added to the white list.

The white list is provided by the server 14 to the local computer 10 at step S4. The kernel of operating system of the computer allows S16 only software listed in the local white list and in the global list to run. In one example, if the software is not on the combination of local and global white lists, a message is automatically generated informing the user that the software is not on the white lists and the software is prevented from running.

A message identifying software having a higher risk is provided to the network manager for review as at step S14. The message may also include the calculated risk factor. In one example if the risk is deemed medium, the message is sent to one manager or group of managers authorized to review and take decisions on medium risk software and if the risk is deemed high, the message is sent to another manager or group of managers authorized to review and take decisions on high risk software.

The relevant manager may request information from the user of the medium or high risk software. For example the manager may ask the user to provide license information. If the user has downloaded the software from a website, the manager may ask for the URL of the website.

If a manager is deems software referred to him is allowable the manager adds it to the local white list at step S14.

The steps S2 to S14 may be repeated continuously or regularly or at suitable intervals to maintain the white lists as software installed on the computer 10 changes over time.

Step S8 lists criteria a)i) to c) iii). However other criteria may be used instead of those or in addition to those. Examples of other criteria which may be used include

Has the software a certificate issued by a trusted certificate authority?

Has the software a product code applied by an installer, for example Microsoft Installer?

### Global White List

The server 12 having the global active directory stores a global white list. Referring to FIG. 4, the server 14 compares S40 all the local white lists it produces. The server 14 has a global assessment program which calculates for each software item on the local white lists the percentage of local white lists listing that software. If a predetermined percentage X%, (for example 30% or any other suitable proportion), of white lists include a particular software, it is added S42 automatically to the global white list in the GAD server. The global white list in the GAD server is enforced S44 on the local computers 10 as a policy.

FIG. 5 illustrates part of a Configuration Manager. The CFM database 21 has an application execution history table containing the execution history 210 for different Applications that have run on client systems. This history is created automatically and is part of the standard inventory process. The database holds the metadata for each system and its Application launch history such as the Name and Version 211, and Publisher 212 which it reads from the binary data of the Application. Additionally this contains the location 213 on the client system that the Application was run from and the date/time 214 this took place.

The CFM database also has an installation package table 220. The installation package table 220 stores data relating to ‘packages’ used for installing software on domain systems. Administrative staff create these Packages over time. The database holds metadata for each package such as the Name 221, Manufacturer 222, version, GUID (unique identifier) 223 and command lines 224 for installing or uninstalling the software.

The software for determining whether an application is tied to the CFM_compares the fields from the two package tables of the database and assigns confidence levels (low, medium and high) on the number of matches from fields in the Application and fields in all the Packages. If all fields match exactly there is high confidence, if only a couple match there is medium confidence and no matches means low confidence.

### Programs

Examples as described herein may be implemented by a suite of computer programs which when run on one or more computer devices of the network. For example, a computer program run on a server computer device may implement the method of FIGS. 3, and/or 4. This provides an efficient technical implementation that is easy to reconfigure; however, other implementations may comprise a hardware-only solution or a mixture of hardware devices and computer programs. One or more computer programs that are supplied to implement the invention may be stored on one or more carriers, which may also be non-transitory. Examples of non-transitory carriers include a computer readable medium for example a hard disk, solid state main memory of a computer, an optical disc, a magneto-optical disk, a compact disc, a magnetic tape, electronic memory including Flash_memory, ROM, RAM, a RAID or any other suitable computer readable storage device.

The term “software” as used herein refers to any tool, function or program that is implemented by way of computer program code other than core operating system code. In use, an executable form of the computer program code is loaded into memory (e.g. RAM) and is processed by one or more processors. “Software” includes, without limitation: non-core operating system code; application programs; patches for, and updates of, software already installed on the network; and new software packages.

The above embodiments are to be understood as illustrative examples of the invention. Further embodiments of the invention are envisaged. Whilst for example the configuration manager, Global Active Directory and the global assessment have been described as implemented by computers 2, 12 and 14 respectively, they may be implemented by one or more other computers. Applications automatically added to the white list because they are deemed to be of low risk may be reviewed by network managers and subsequently removed if the managers decide they are of higher risk. It is to be understood that any feature described in relation to any one embodiment may be used alone, or in combination with other features described, and may also be used in combination with one or more features of any other of the embodiments, or any combination of any other of the embodiments. Furthermore, equivalents and modifications not described above may also be employed without departing from the scope of the invention, which is defined in the accompanying claims.

What is claimed is:

1. A method of controlling a first computer in a communications network, the first computer having an operating system having a kernel, the operating system being configured to prevent running of software not identified in a list of approved software, the method comprising:
running a monitoring program on the first computer which provides to a second computer data relating to items of software installed on the first computer;
running on the second computer a comparison program which compares the identities of the items of software present on the first computer with approved software identified in the list of approved software, and a risk determination program which determines for each item of software present on the first computer and not on the list of approved software whether it poses a high risk or a low risk, wherein the determination is based on a plurality of risk criteria, and automatically adds to the list of approved software the identity of any item of software present on the first computer determined to be of low risk; and
supplying the list of approved software to the first computer whereby the operating system of the first computer prevents the running any item of software absent from the list.

2. The method of claim 1, wherein the risk determination is further based on a calculated risk metric dependent on the plurality of risk criteria.

3. The method of claim 2, wherein the calculated risk metric is a weighted sum of confidence values associated with the respective criteria.

4. The method of claim 1, wherein the plurality of risk criteria include whether the software has a compile time populated producer name, product name, version name and date.

5. The method of claim 1, wherein plurality of risk criteria include whether the software has a security certificate.

6. The method of claim 1, wherein plurality of risk criteria include the identity of where the software runs from on the first computer.

7. The method of claim 1, wherein the criteria include whether the software on the first computer runs from the network.

8. The method of claim 1, wherein the communications network includes a network management system, and wherein the network management system includes an installation system, and wherein the plurality of risk criteria include whether the software on the first computer was installed using the installation system or independently of the network management system.

9. The method of claim 8, wherein plurality of risk criteria include whether the software on the first computer has a software identification code associated with the installation system.

10. The method of claim 7, wherein the communications network includes a plurality of first computers and includes a computer having a global active directory and storing in association with the directory a global list of approved software, and the second computer has a comparison program for comparing lists of approved software of first computers of the network, the method comprising using the monitoring program to monitor the approved lists of the first computers on the network, determine the proportion of lists listing the same item of software, updating the global list to include that item if the proportion exceeds a predetermined amount, the operating system of each first computer preventing running of software absent from the combination of the global list and its local list.

11. A non-transitory computer readable medium comprising computer-executable instructions which, when executed by a processor, cause a computing device to perform a method for controlling a first computer having an operating system having a kernel, the operating system being configured to prevent running of software not identified in a list of approved software, the method comprising:
receiving from the first computer data relating to software installed on the first computer;
comparing the identities of software present on the first computer with software identified in the list,
determining for each software on the first computer and not on the list whether the software on the first computer complies with a plurality of risk criteria, and automatically add to the list the identity of any software on the first computer determined to be of low risk; and
sending the list to the first computer.

12. The non-transitory computer-readable medium of claim 11, wherein the risk determination program calculates a risk metric dependent on the risk criteria.

13. The non-transitory computer-readable medium of claim 11, wherein the risk metric is a weighted sum of confidence values associated with the respective criteria.

14. The non-transitory computer-readable medium of claim 11, wherein criteria include whether the software on the first computer has a compile time populated producer name, product name, version name and date.

15. The non-transitory computer-readable medium of claim 11, wherein criteria include whether the software on the first computer has a security certificate.

16. The non-transitory computer-readable medium of claim 11, wherein criteria include the identity of where the software on the first computer runs from on the computer.

17. The non-transitory computer-readable medium of claim 11, for use wherein the first computer is in a network and the criteria include whether the software on the first computer runs from the network.

18. The non-transitory computer-readable medium of claim 11, for use wherein first computer is in a network having a network management system including an installation system and the criteria include whether the software on the first computer was installed using the installation system or independently of the network management system.

19. The non-transitory computer-readable medium of claim 18, wherein criteria include whether the software on the first computer has a software identification code associated with the installation system
